(19) United States
(12) Patent Application Publication
(10) Pub. No.: US 2021/0199145 A1
(43) Pub. Date: Jul. 1, 2021

(54) ANCHOR BOLT FOR HOLLOW WALL

(71) Applicant: Core Bolt Co., Ltd., Gwangju (KR)

(72) Inventor: Young Kwon KIM, Haenam-gun (KR)

(73) Assignee: Core Bolt Co., Ltd., Gwangju (KR)

(21) Appl. No.: 16/851,055

(22) Filed: Apr. 16, 2020

(30) Foreign Application Priority Data
Dec. 31, 2019 (KR) 10-2019-0179085

(51) Int. Cl. F16B 13/06

(52) U.S. Cl. CPC F16B 13/06

(57) ABSTRACT

Disclosed herein is an anchor bolt for a hollow wall including: a core shaft having an inner bolt insertion hole perforated therein in an axial direction; an inner bolt screw-coupled to the inner bolt insertion hole; and an expansion locking tube arranged between the core shaft and the inner bolt to surround the inner bolt. The expansion locking tube and the inner bolt are combined with the core shaft and are inserted into a through hole of the hollow wall. When the inner bolt is screw-coupled to the inner bolt insertion hole and is inserted into the core shaft, the expansion locking tube is bent to be expanded outwards in a radial direction of the core shaft so that an elastic force is applied in a resistant direction to a direction that the core shaft is outwardly separated from the through hole.

### CROSS-REFERENCE TO PRIOR APPLICATIONS

The application claims priority of Korean Patent Application No. 10-2019-0179085, filed on Dec. 31, 2019, which is hereby incorporated by reference in its entirety.

### BACKGROUND OF THE INVENTION

### Field of the Invention

The present invention relates to an anchor bolt for a hollow wall, and more particularly, to an anchor bolt for a hollow wall, which can prevent rotation in a state where the anchor bolt is inserted into a through hole of the hollow wall and can be firmly fixed.

### Background Art

In general, an anchor bolt is to install and fix various exterior materials or structures on a concrete wall body or the floor, and is inserted into a hole, which is bored by a drill, not to be fixed. A user can install and fix an exterior material or a structure using such an anchor bolt.

However, when the structure is installed after a conventional anchor bolt is inserted into the hole, the anchor bolt has a disadvantage in that it does not fit or is not fixed properly in the hole.

In order to solve such a problem, the inventor of the present invention has developed an anchor bolt 10 shown in FIGS. 1A and 1B. As shown in FIG. 1A, the conventional anchor bolt 10 includes: a headless bolt 11 inserted into a through hole B of a hollow wall A; an inner bolt 12 inserted into the headless bolt 11; and an expansion wing 13 disposed between the inner bolt 12 and the headless bolt 11.

As shown in FIG. 1B, when the inner bolt 12 is inserted into the headless bolt 11, the expansion wing 13 is expanded and supported by getting in contact with the surface of the hollow wall A, so as to support rotation and movement of the headless bolt 11.

However, such an anchor bolt 10 still has the problem that the headless bolt 11 is rotated or shaken from side to side in the through hole B when being used for a long time since power of the expansion wing 13 to support the hollow wall A is weak.

When the headless bolt 11 is rotated or shaken, because the structure or tools combined with the headless bolt 11 are not also fixed, and it may cause a safety accident.

### SUMMARY OF THE INVENTION

Accordingly, the present invention has been made to solve the above-mentioned problems occurring in the prior arts, and it is an object of the present invention to provide an anchor bolt for a hollow wall, which can be firmly fixed when being fastened into a through hole of the hollow wall.

To accomplish the above object, according to the present invention, there is provided an anchor bolt for a hollow wall including: a core shaft having an inner bolt insertion hole perforated therein in an axial direction; an inner bolt screw-coupled to the inner bolt insertion hole; and an expansion locking tube arranged between the core shaft and the inner bolt to surround the inner bolt.

Here, the expansion locking tube and the inner bolt are combined with the core shaft and are inserted into a through hole of the hollow wall. When the inner bolt is screw-coupled to the inner bolt insertion hole and is inserted into the core shaft, the expansion locking tube is bent to be expanded outwards in a radial direction of the core shaft so that an elastic force is applied in a resistant direction to a direction that the core shaft is outwardly separated from the through hole.

The anchor bolt for the hollow wall according to the present invention is bent outwards in the radial direction to be expanded outwards by pressurizing power generated when the inner bolt lowers down in the state where the lower portions of the bent wings of the expansion locking tube are inserted into the through hole.

Elastic power is applied in the direction that the outer diameter is expanded while the bent wings are bent outwardly in the radial direction. Therefore, the bent wings are firmly fit to the inner wall surface of the through hole and to the boundary area between the through hole and the hollow wall surface to be limited in its position.

Therefore, even though external force is applied to the core shaft combined with the inner bolt, it is prevented that the inner bolt is rotated idly or moved inside the through hole.

Furthermore, the rotation of the core head is limited by the cap combined with the core shaft, and the user can easily fix various tools to the hollow wall through the cap fixing bolt combined with the cap.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIGS. 1A and 1B show an example of a fastening structure of a conventional anchor bolt;

FIG. 2 is a perspective view showing a fastening structure of an anchor bolt according to the present invention;

FIGS. 3 and 4 are exploded perspective view showing a structure of the anchor bolt according to the present invention; and

FIGS. 5A to 7B are views showing examples of a process of fastening the anchor bolt according to the present invention to a hollow wall.

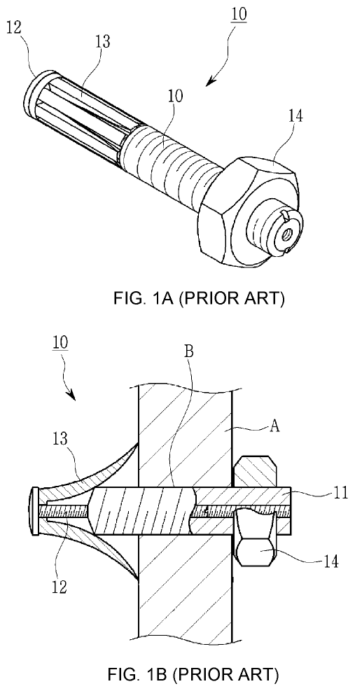

### DETAILED DESCRIPTION OF THE PREFERRED EMBODIMENT

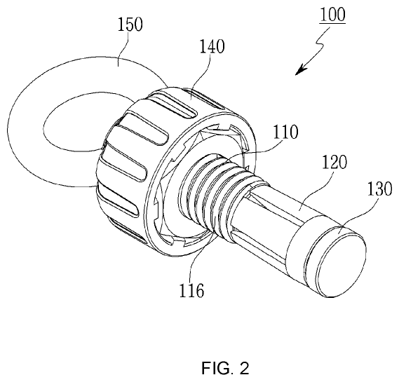

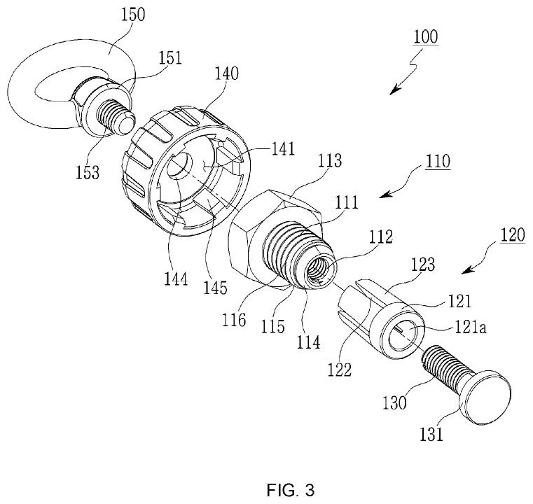

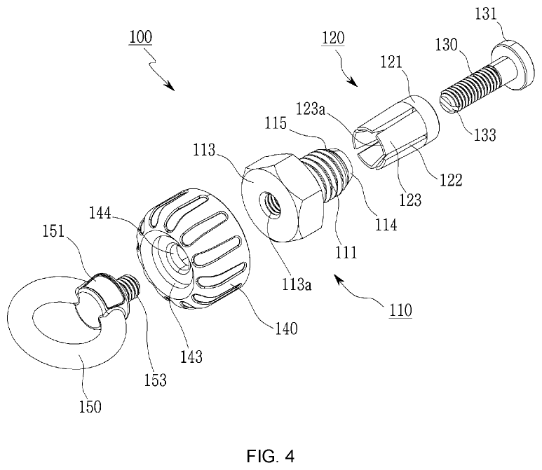

FIG. 2 is a perspective view showing a fastening structure of an anchor bolt 100 according to the present invention, and FIGS. 3 and 4 are exploded perspective view showing a structure of the anchor bolt 100 according to the present invention.

As shown in the drawings, the anchor bolt 100 for a hollow wall according to the present invention is fastened to the hollow wall so that lightings or a structure (not shown) attached to a wall body or the ceiling can be stably fastened.

Here, the hollow wall A used in the present invention means a ceiling finishing material or a wall body material after an insulator is closely constructed from an outer wall and is finished inside. The hollow wall A is mainly made with gypsum board or woodblock materials.

The anchor bolt 100 for the hollow wall according to the present invention is fastened to a through hole B perforated by a drill in order to fix the structure (not shown).

The anchor bolt 100 for the hollow wall according to the present invention includes a core shaft 110, an inner bolt 130 inserted into the core shaft 110, and an expansion locking tube 120 arranged to surround the inner bolt 130.

The anchor bolt 100 for the hollow wall is inserted into the through hole B of the hollow wall A after being assembled outside the hollow wall. After the anchor bolt 100 for the hollow wall is inserted into the through hole B in the state where the anchor bolt 100 is assembled, the expansion locking tube 120 is expanded outwardly while being bent outwards in a radial direction in interconnection with that the inner bolt 130 is inserted into the core shaft 110, so that an elastic force is applied in a resistant direction to a direction that the anchor bolt 100 is outwardly separated from the through hole B.

Therefore, the anchor bolt 100 for the hollow wall can maintain the position stably without spinning idly or moving in the state where the anchor bolt 100 is fastened to the hollow wall.

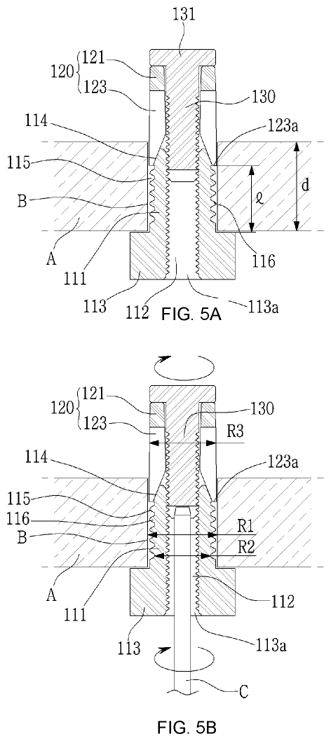

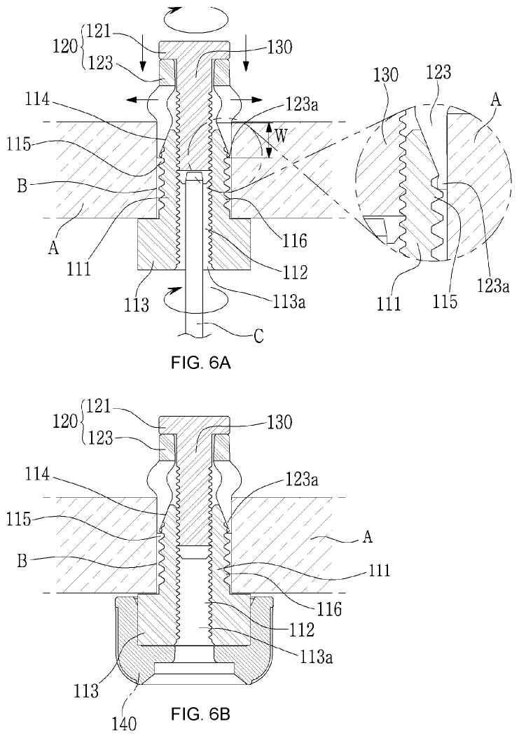

FIGS. 5 to 6 are views showing examples of a process of fastening the anchor bolt 100 according to the present invention to the through hole B of the hollow wall A.

The core shaft 110 is screw-coupled with the inner bolt 130. The core shaft 110 includes a shaft body 111 and a core head 113 disposed at one end of the shaft body 111 to be supported on a plate surface of the hollow wall A. An inclined surface 114 extends from the other end of the shaft body 111 in a predetermined length and has a diameter getting smaller. An inner bolt insertion hole 112 is formed in the shaft body 111, the inclined surface 114 and the core head 113 to be perforated in a longitudinal direction. A screw thread 116 is formed on the outer circumference of the shaft body 111 in a spiral direction.

As shown in FIG. 5B, the shaft body 111 has an outer diameter R2 which is smaller than a diameter R1 of the through hole B so as to be easily inserted into the through hole B. The inner bolt insertion hole 112 formed in the shaft body 111 and the inclined surface 114 has a screw thread formed on the inner wall surface thereof to be screw-coupled with the inner bolt 130.

The inclined surface 114 is formed on an end portion of the shaft body 111 in a predetermined length in order to guide bent wings 123 of the expansion locking tube 120 toward the shaft body 111.

Here, a length k of the shaft body 111 is formed to be smaller than a thickness d of the hollow wall A. Therefore, when the expansion locking tube 120 is inserted into the through hole B, as shown in FIG. 6A, the inclined surface 114 and the bent wings 123 of the expansion locking tube 120 are overlapped in a predetermined length W, and the bent wings 123 may be bent outwards.

In the meantime, as shown in FIG. 5B, a wing position fixing protrusion 115 located at the lowermost part of the screw thread 116 serves to limit the position of the bent wings 123 in order to prevent the bent wings 123 from lowering along the shaft body 111 anymore when the bent wings 123 of the expansion locking tube 120 located on the inclined surface 114 of the shaft body 111 lower down along the inclined surface 114 by rotation of the inner bolt 130 as shown in FIG. 6A.

The wing position fixing protrusion 115 protrudes outwards in the radial direction of the shaft body 111 to block a space between the shaft body and the inner wall surface of the through hole B. Wing end portions 123a of the bent wings 123 lowering down along the inclined surface 114 get in contact with the wing position fixing protrusion 115 so as not to lower toward the shaft body 111 anymore.

The bent wings 123 which are blocked by the wing position fixing protrusion 115 not to lower anymore are expanded outwardly while being bent outwards in the radial direction, so that an elastic force is applied in the resistant direction to the direction that the anchor bolt 100 is outwardly separated from the through hole B.

The core head 113 is disposed at a lower portion of the shaft body 111, and is arranged on the plate surface of the hollow wall A. The core head 113 is formed to be larger than the diameter of the through hole B and is not inserted into the through hole B to be supported by getting in contact with the hollow wall A.

The core head 113 has an operating tool insertion hole 113a in which an operating tool C is inserted, and the operating tool insertion hole 113a is formed to communicate with the inner bolt insertion hole 112. As shown in FIG. 5B, the core head 113 in which the operating tool C is inserted rotates the inner bolt 130 inserted into the inner bolt insertion hole 112.

Here, the core shaft 110 according to the preferred embodiment of the present invention is has the structure that the core head 113 is combined integrally with the shaft body 111, but it is just one embodiment of the present invention, and as occasion demands, the core shaft 110 may be a headless bolt which has no core head. In this instance, a nut (not shown) is coupled with an end portion of the headless bolt protruding outwards from the hollow wall A in order to fix the position of the headless bolt.

Furthermore, the core head 113 may be formed in a hexagonal shape as illustrated in the drawing, or may have any one among various shapes.

The expansion locking tube 120 is located between the core shaft 110 and the inner bolt 130, is bent outwards in the radial direction by pressure generated when the inner bolt 130 is inserted into the core shaft 110, and supports the through hole B and the surface of the hollow wall A by getting in contact with them so as to prevent rotation and movement of the core shaft 110.

As shown in FIGS. 3 and 4, the expansion locking tube 120 includes a rim 121 onto which the inner bolt 130 is fit, and the plurality of bent wings 123 formed downwards along the circumferential direction of the rim 121 in a predetermined length. As shown in FIG. 5A, the rim 121 is arranged at the bottom of the bolt head 131 of the inner bolt 130 and guides the inner bolt 130 toward the core shaft 110. For this, an inner bolt coupling hole 121a, in which the inner bolt 130 is inserted, is perforated through the surface of the rim 121.

The plurality of bent wings 123 extend downwards from the rim 121 in a predetermined length. The plurality of bent wings 123 are independently formed by a cut line 122, and can be transformed flexibly in interconnection with lowering of the inner bolt 130. As shown in FIG. 5A, the bent wings 123 are formed to get thinner toward the wing end portion 123a.

When the inner bolt 130 is inserted into the core shaft 110, the wing end portions 123a of the bent wings 123 are located to touch the inclined surface 114. In this instance, because the wing end portions 123a are formed to get thinner in the downward direction, the wing end portions 123a engage with the inclined surface 114 and cover the inclined surface 114.

Here, as shown in FIG. 5B, it is preferable that the expansion locking tube 120 have a length that the wing end portions 123a of the bent wings 123 is inserted into the through hole B to cover a part of the inclined surface 14 in an initial state that the inner bolt 130 is inserted into the core shaft 110 but is not rotated by the operating tool C.

The inner bolt 130 is inserted into the core shaft 110 and pressurizes the expansion locking tube 120 so that the bent wings 123 are transformed flexibly. The inner bolt 130 is inserted into the inner bolt insertion hole 112 of the core shaft 110, is screw-coupled with the inner bolt insertion hole 112 by rotation of the operating tool C, and pressurizes the expansion locking tube 120 while being inserted further inwards.

The bolt head 131 is formed integrally on the upper portion of the inner bolt 130. The bolt head 131 is arranged at the top of the rim 121 of the expansion locking tube 120. A tool combining groove 133 to which the operating tool C is combined is formed at the bottom of the inner bolt 130.

Preferably, the inner bolt 130 has a length that the wing end portions 123a of the bent wings 123 can meet the inclined surface 114 in the initial state shown in FIGS. 5A and 5B.

Referring to FIGS. 2 to 6, a construction process of the anchor bolt 100 for the hollow wall according to the present invention will be described.

As shown in FIGS. 3 and 4, a user inserts the inner bolt 130 into the inner bolt combining hole 121a formed in the rim 121 of the expansion locking tube 120. The inner bolt 130 is inserted into the inner bolt insertion hole 112 of the shaft body 111 of the core shaft 110.

The inner bolt 130 with which the expansion locking tube 120 is combined is assembled to the core shaft 110, and then, as shown in FIG. 5A, is inserted into the through hole B of the hollow wall A. In the state where the inner bolt 130 is inserted into the inner bolt insertion hole 112, the wing end portions 123a of the plurality of bent wings 123 of the expansion locking tube 120 are located to touch the inclined surface 114.

As shown in FIG. 5B, the user inserts the operating tool C into the operating tool insertion hole 113a of the core head 113, puts the operating tool C in the tool combining groove 133 of the inner bolt 130, and then, rotates the operating tool C. Then, the inner bolt 130 is rotated, is screw-coupled with the inner bolt insertion hole 112, and is inserted into the inner bolt insertion hole 112.

When the inner bolt 130 is rotated and lower down into the inner bolt insertion hole 112, the expansion locking tube 120 combined with the outside of the inner bolt 130 is also rotated, and the bent wings 123 lower down along the inclined surface 114.

Additionally, as shown in FIG. 6A, when the wing end portions 123a of the bent wings 123 touch the wing position fixing protrusion 115, it is limited that the bent wings 123 are moved toward the shaft body 111 further by the wing position fixing protrusion 115.

When the operating tool C is continuously rotated, the inner bolt 130 gradually lowers toward the shaft body 111 and pressurizes the expansion locking tube 120. The plurality of bent wings 123 is bent flexibly and outwardly in the radial direction since the wing end portions 123a of the lower end portion are caught to the wing position fixing protrusion 115 and cannot lower down anymore.

The plurality of bent wings 123 are bents outwardly in the radial direction in a boundary area between the through hole B of the hollow wall A and the bent wings 123, and are expanded outwards. When the bent wings 123 are bent, the wing end portions 123a cover the inclined surface 114 and fill the space between the through hole B and the bent wings 123. The bent wings 123 are bent between the rim 121 and the through hole B and apply elasticity in a direction to maintain the state where the bent wings 123 are inserted into the through hole B.

That is, in the state where the bent wings 123 are bent, resistance is applied to the inner wall surface of the through hole B and the outer surface of the hollow wall A in the resistant direction to the direction that the expansion locking tube 120 is outwardly separated from the through hole B.

Even though external force acts to the core shaft 110 by a shape strain that the expansion locking tube 120 is bent to be expanded outwards in the radial direction, it is difficult to release the state where the bent wings 123 are forcedly fit to the through hole B. Therefore, even though the external force acts, the core shaft 110 stably keeps its position without being rotated idly or moved from side to side in the through hole B.

In the meantime, the anchor bolt 100 for the hollow wall according to the present invention may further include a cap 140 and a cap fixing bolt 150 in order to combine various tools with the hollow wall A.

The cap 140 accommodates the core head 113 therein and serves as a grip to fix the position of the core head 113 to prevent double rotation when the inner bolt 130 is fastened by the operating tool C. Moreover, the cap 140 also serves as an interior decoration to prevent the core head 113 of the core shaft 110 from being exposed to the outside.

The cap 140 includes a core head receiving space 141 in which the core head 113 is accommodated. In this instance, as shown in FIG. 3, a plurality of core head support protrusions 145 are disposed on the inner wall surface of the cap 140 to prevent rotation of the core head 113 by supporting the polygonal core head 113 in contact with the core head 113 accommodated in the core head receiving space 141.

Meanwhile, a cap fixing bolt head insertion groove 143 is formed in the upper surface of the cap 140 to be recessed to a predetermined depth and the cap fixing bolt head 151 of the cap fixing bolt 150 is inserted into the cap fixing bolt head insertion groove 143. A cap fixing bolt shaft insertion hole 144 is formed in the middle area of the cap fixing bolt head insertion groove 143, and the cap fixing bolt shaft 153 is inserted into the cap fixing bolt shaft insertion hole 144.

The cap fixing bolt 150 serves to fix the cap 140 to the core head 113. The cap fixing bolt 150 is combined with the core head 113 through the cap 140. The cap fixing bolt head 151 and the cap fixing bolt shaft 153 are disposed on the cap fixing bolt 150.

As shown in FIG. 6B, when the core shaft 110 and the inner bolt 130 are firmed fixed in the through hole B by the expansion locking tube 120, the user fits the cap 140 to the core head 113. The core head 113 is accommodated in the core head receiving space 141 of the cap 140.

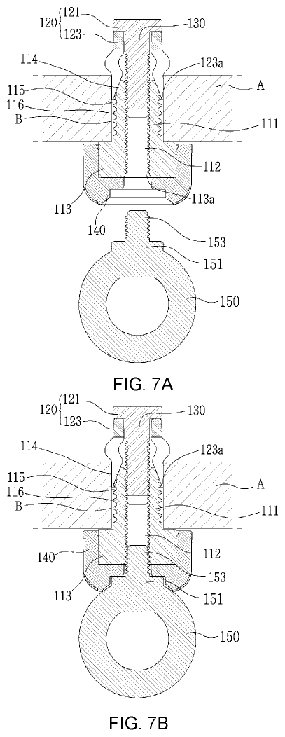

Additionally, as shown in FIG. 7A, the user combines the cap fixing bolt 150 with the cap 140. As shown in FIG. 7B, the user screw-couples the cap fixing bolt shaft 153 to the operating tool insertion hole 113a of the core head 113 through the cap fixing bolt shaft insertion hole 144 so as to fix the cap fixing bolt 150 to the core head 113.

After fixing the cap fixing bolt 150 to the core head 113, the user joins a desired structure (not shown) with the cap fixing bolt 150 to be caught to the cap fixing bolt 150 so that the structure (not shown) can be fixed to the hollow wall A.

In the meantime, if the user wants to dismantle the anchor bolt 100 from the hollow wall, on the contrary to the combining structure, the user separates the cap 140 from the cap fixing bolt 150, inserts the operating tool C into the inner bolt insertion hole 112 of the core shaft 110, and then, rotates the inner bolt 130 in a direction to release the screw-coupling. Then, the inner bolt 130 is separated outwards from the core shaft 110, and the bent wings 123 are spread again.

The anchor bolt for the hollow wall according to the preferred embodiment of the present invention has the screw thread spirally formed on the outer circumferential surface of the core shaft in the longitudinal direction. However, as occasion demands, the screw thread may not be formed on the outer circumferential surface of the core shaft. In this instance, the outer diameter of the core shaft is formed corresponding to the inner diameter of the through hole so that the bent wings are fit to the space between the core shaft and the through hole and are expanded outwardly.

As described above, when the inner bolt is rotated in the state where the lower portions of the bent wings of the expansion locking tube are inserted into the through hole, the bent wings are bent outwardly in the radial direction by pressurizing power generated when the inner bolt is inserted so that the outer diameter is expanded.

Elastic power is applied in the direction that the outer diameter is expanded while the bent wings are bent outwardly in the radial direction. Therefore, the bent wings are firmly fit to the inner wall surface of the through hole and to the boundary area between the through hole and the hollow wall surface to be limited in its position.

Therefore, even though external force is applied to the core shaft combined with the inner bolt, it is prevented that the inner bolt is rotated idly or moved inside the through hole.

Additionally, the anchor bolt for the hollow wall according to the present invention facilitate mechanism operation by the cap combined with the core head, and can be firmly and easily fastened to the hollow wall since it does not need any bracket as a fastened object screw-coupled to the operating tool insertion hole.

What is claimed is:

1. An anchor bolt for a hollow wall comprising:
a core shaft having an inner bolt insertion hole perforated therein in an axial direction;
an inner bolt screw-coupled to the inner bolt insertion hole; and
an expansion locking tube arranged between the core shaft and the inner bolt to surround the inner bolt,
wherein the expansion locking tube and the inner bolt are combined with the core shaft and are inserted into a through hole of the hollow wall, and
wherein when the inner bolt is screw-coupled to the inner bolt insertion hole and is inserted into the core shaft, the expansion locking tube is bent to be expanded outwards in a radial direction of the core shaft so that an elastic force is applied in a resistant direction to a direction that the core shaft is outwardly separated from the through hole.

2. The anchor bolt according to claim 1, wherein the core shaft includes a shaft body, and a core head disposed at one end of the shaft body and supported on the hollow wall by getting in contact with the hollow wall,
wherein an inclined surface is formed at the other end of the shaft body in a predetermined length and has a diameter getting smaller toward an end portion,
wherein the expansion locking tube includes a plurality of bent wings formed to be flexibly transformed by a cut line formed to the end portion of the expansion locking tube along the outer circumferential surface at intervals of a predetermined angle,
wherein when the inner bolt is combined with the core shaft and is inserted into the through hole, wing end portions of the plurality of bent wings are arranged at an upper end of the inclined surface, and
wherein when the inner bolt is rotated and is inserted into the shaft body, the plurality of bent wings is pressurized inwards and the wing end portions are caught to an outer diameter of the shaft body after being moved along the inclined surface, and then, the bent wings are bent flexibly and outwardly from the through hole so that the outer diameter is expanded.

3. The anchor bolt according to claim 2, wherein the wing end portions are forcedly fit to a space between the inclined surface and the through while being moved along the inclined surface in the direction of the core head,
wherein the bent wings are expanded outwardly to form elastically repulsive power while pressure is applied to the bent wings,
wherein the shaft body is formed to be shorter than thickness of the hollow wall, and
wherein the plurality of bent wings gets thinner toward a lower end portion thereof.

4. The anchor bolt according to claim 3, further comprising:
a cap for covering the core head; and
a cap fixing bolt which penetrating through the cap to fix the cap to the core head, and has a cap support bolt head having a diameter larger than a cap fixing bolt shaft insertion hole formed in the cap.
